(19) United States
(12) Patent Application Publication
(10) Pub. No.: US 2014/0304696 A1
(43) Pub. Date: Oct. 9, 2014

(54) ARRANGEMENT FOR UPDATING A CONTROL SYSTEM

(71) Applicants: Arttu Rantanen, Tampere (FI); Janne Viitala, Tampere (FI); Eemeli Haverinen, Tampere (FI)

(72) Inventors: Arttu Rantanen, Tampere (FI); Janne Viitala, Tampere (FI); Eemeli Haverinen, Tampere (FI)

(73) Assignee: SANDVIK MINING AND CONSTRUCTION OY, Tampere (FI)

(21) Appl. No.: 14/350,833

(22) PCT Filed: Oct. 11, 2011
(86) PCT No.: PCT/FI2011/050874

§ 371 Date: Apr. 23, 2014

(51) Int. Cl. G06F 9/445

(52) U.S. Cl. CPC G06F 8/65
USPC 717/169

(57) ABSTRACT

A method for updating software of a control system of a working machine includes creating an installation file structure having an installation application and files and data for the update of the control system; storing the installation file structure on a portable memory medium; connecting the portable memory medium to the control system of the working machine; and starting an update process from the installation file structure in response to a command from a control panel node of the working machine.

### FIELD OF THE INVENTION

The present invention relates to working machines, and more particularly to an arrangement for updating a control system of a working machine.

### BACKGROUND OF THE INVENTION

Contemporary heavy-duty vehicles and working machines, such as various mining apparatuses, are typically provided with software-based control system architecture. The operations of the apparatus are controlled by various hardware components, also referred to as nodes, such as processors, programmable logic nodes, sensors, actuators, etc., which nodes in turn are controlled by various software modules and components arranged to carry out operations relating to machine control, safety, diagnostics, parameter management, etc. The hardware and software components are normally connected to each other via a control bus.

As a part of the development of the apparatuses, also the control system architecture and the related software are continuously developed and new versions of control software are released to be updated, for example as a part of a service program of the apparatuses. Further, as a result of maintenance of the apparatus, the configuration of the hardware components may be changed. This may also require an update of software and firmware of the component.

However, the hardware components are usually provided from a plurality of vendors, and control messages for components of each vendor are typically not compatible with those of other vendors. Moreover, the vendors may use a variety of communication protocols for transmitting the control messages. Consequently, the software modules of each component may have to be updated individually through a slow process carried out by personnel with special skills in computing.

Such apparatuses are often operated in rural areas, possibly deep down in an underground mine, i.e. in an environment where no network connections are available. On the other hand, taking the apparatus to the closest service point or even in connection with a communication network for the update may interrupt the operation of the apparatus for a long time. Moreover, updating only certain software modules of a large control system may lead to instability and unwanted errors within the control system, if the update process is not controlled by personnel with special skills in computing. However, it is not practical to arrange such personnel to travel on-site for each update task.

### SUMMARY OF THE INVENTION

An improved method and technical equipment implementing the method has now been developed for updating a control system of a mining apparatus. Various aspects of the invention include a method, a working machine, a control system and a computer program product, which are characterized by what is stated in the independent claims. Various embodiments of the invention are disclosed in the dependent claims.

According to a first aspect, a method according to the invention is based on the idea of updating software of a control system of a working machine, the method comprising: creating an installation file structure comprising an installation application and files and data for the update of the control system; storing said installation file structure on a portable memory medium; connecting said portable memory medium to the control system of the working machine; and starting an update process from said installation file structure in response to a command from a control node of the working machine.

According to a second aspect, there is provided a working machine comprising: a software-based control system; means for connecting a portable memory medium to the control system; and means for providing a user command for starting an update process of the control system from an installation file structure stored on said portable memory medium.

According to an embodiment, the installation file structure comprises an installation application and files and data necessary for the update of the control system

According to an embodiment, the portable memory medium is a USB flash drive.

According to an embodiment, the installation application is arranged to carry out the update process as a full upgrade, wherein control software modules of each node of the control system are upgraded.

According to an embodiment, the installation application is arranged to carry out the update process as a partial upgrade, wherein control software modules of one or more nodes of the control system are upgraded.

According to an embodiment, the installation application is arranged to carry out the update process as a fresh installation, wherein control software modules of one or more nodes of the control system are installed without a prior version of the control software module existing on said one or more nodes.

According to an embodiment, said installation file structure is a boot image file, wherein said boot image file comprises the installation application, control system release-specific kernel and system files, control system release-specific binary files and application-specific binary files.

According to an embodiment, a display unit of the control panel comprises said means for providing the command starting the update process; and said display unit is arranged to receive information regarding the progress of the upgrade process from the installation application to be shown on the display unit.

According to an embodiment, the control system is arranged to check access rights of a user of the mining apparatus; and allowing the command starting the update process to be provided only in response to the access rights of the user being on a predetermined level.

According to an embodiment, the working machine is one of the following: a drill rig, a loader, a dumper, a crushing and screening apparatus, a conveyor, a road header, a continuous miner or a bulk material handling device.

These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIGS. 1a, 1b, 1c show simplified example layouts of a control platform for a mining apparatus;

FIG. 2 shows an arrangement for upgrading software and/or firmware of the control system of a mining apparatus according to an embodiment of the invention;

FIG. 3 shows an example of preparing an update image into a portable memory medium according to an embodiment of the invention;

FIG. 4 shows an upgrade process of the control system according to an embodiment of the invention; and

FIG. 5 shows a block diagram of a system for carrying out an upgrade process of a control system of a work machine.

### DESCRIPTION OF EMBODIMENTS

The presently disclosed embodiments are applicable, in particular, to control systems relating to various working machines. Examples of such working machines are a drill rig, a loader, a dumper, a crushing and screening apparatus, a conveyor, a road header, a continuous miner, or a bulk material handling device. The operations of such working machine may be automated or semi-automated. Particular examples of working machines are mining and construction apparatuses required in mining industry, such as various mobile rock drilling, loading and transport machines. A mining apparatus may be a mobile mining apparatus, which may be referred to as a mining vehicle, or a stationary mining apparatus. The application of the present features is not limited to the control system of a mining apparatus illustrated below, but features of the invention may also be applied to control systems of mining apparatus of other types. It should also be noted that, in general, a mining apparatus may also refer to various machines used for rock excavation in a surface or underground operating area.

Mining apparatuses comprise different elements to enable mining operations such as rock excavation. For example, a mining apparatus may comprise a rock drill or another tool which is controlled by a control system. Some mining apparatuses may comprise a crusher for crushing substances such as stones, for example. The tool may be mounted in a carrier of the mining apparatus. Mining apparatuses may further comprise an engine to generate power for moving the mining apparatus, for running a generator to generate electricity for the mining apparatus, and for operating e.g. one or more hydraulic pumps, which may be used to generate pressure for a hydraulic system of the mining apparatus. The hydraulic system may include valves, pipes, hydraulic cylinders etc. The hydraulic cylinders may be used e.g. to move different parts of the mining apparatus such as a drill boom. The rock drill may also use the hydraulic system for drilling. The control system of the mining apparatus may comprise elements for controlling the operation of the hydraulic cylinders and other actuators, which may be present in the mining apparatus.

A user may control the operation of the mining apparatus e.g. by a control panel which may comprise a wheel, a joystick, a display unit, switches and/or some other means for moving the mining apparatus, for positioning the tool, for switching the tool on and off, etc.

Mining apparatuses may have actuators for performing different tasks, sensors to detect states of actuators and/or to measure conditions of different parts of the mining apparatus and possibly to take measurements about the environment, etc. The actuators and sensors may be under the control of a control system, which may comprise a supervisor element providing visual and/or audible information to the user by a user interface (UI), to control the operation of the actuators, to analyze sensor signals, parameters etc. possibly needed in determining the status of the mining apparatus. The user interface provides information to the user, for example via the display unit, and receives user's commands. The control panel may be a part of the user interface and controlled by the supervisor element.

Signals between different parts of the control system may be transferred by a communication network, such as a field bus, a CAN bus (Controller Area Network) or Ethernet. The communication may use one or more higher level protocol such as CANopen, J1939 and/or Profinet. Actuators, sensors and other elements may be connected to the communication network as nodes of the network, or they may be connected with a communication device which is connected to the network to operate as a node. Hence, the communication device can communicate with other parts of the network to receive from the network e.g. commands to be delivered to the actuators and/or to send to the network information obtained, for example, from the sensors. Certain functionality in the device acting as a node is required so that it can attach to the network, send messages to the network and receive messages from the network.

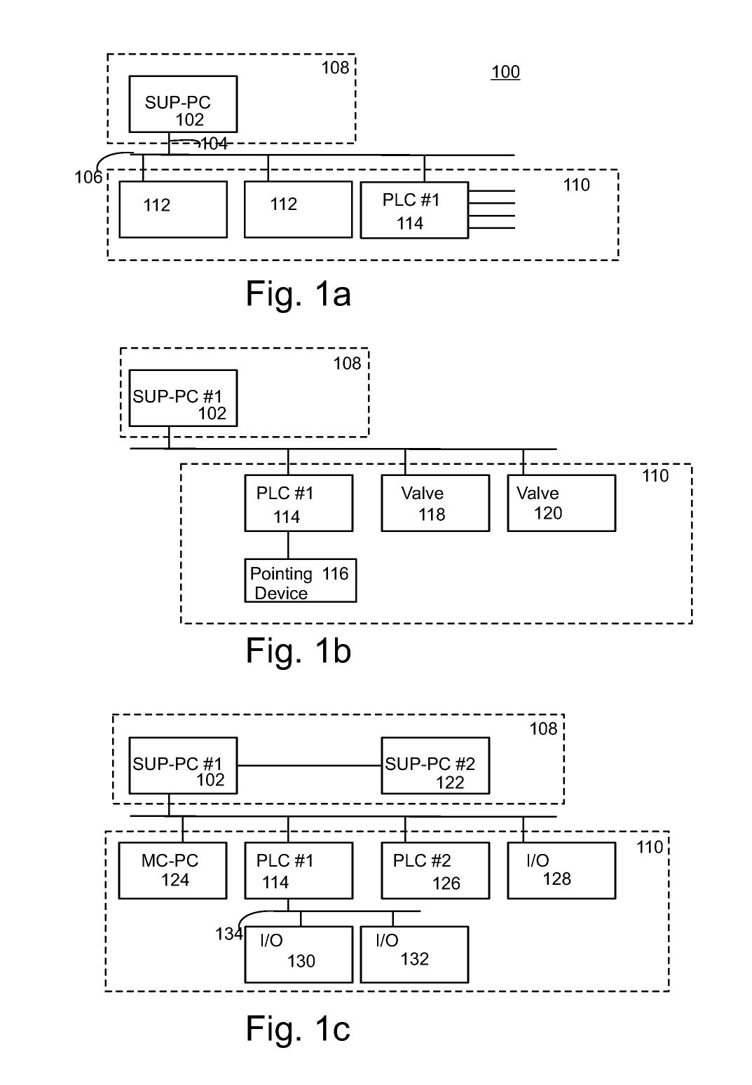

FIG. 1a depicts a simplified example layout of a control platform 100 for a mining apparatus. The control platform includes a supervisor device 102 (SUP-PC#1), such as a computer, which is in a communication connection 104 with a communication network 106. The supervisor device 102 forms a kind of a supervisor level 108 (i.e. a higher control level) of the control platform 100. The control platform 100 also comprises a machine control level 110 (i.e. a lower control level) in which elements connected with different kinds of actuators, sensors etc. are located. The machine control level 110 may comprise one or more nodes 112 for different purposes in communication connection with the communication network 106. The nodes may include a programmable logic controller (PLC) 114 having inputs and outputs for connections to and from the actuators, sensors and other elements of the hardware of the mining apparatus.

FIG. 1b depicts a simplified example layout of another control platform 100, which is intended for a boom control system of the mining apparatus. In this example embodiment the machine control level 110 comprises a pointing device 116 such as a joystick, which is connected to the PLC#1, 114. The machine control level 110 also comprises two valves 118, 120 for the hydraulic cylinders of the boom (not shown in FIG. 1b).

FIG. 1c depicts a simplified example layout of yet another control platform 100 for the mining apparatus. In this example embodiment the supervisor level 108 comprises a first supervisor device SUP-PC#1, 114 and a second supervisor device SUP-PC#2, 122. The machine control level 110 comprises among other things a machine control computer MC-PC 124, several PLC devices PLC#1, 114, PLC#2, 126 some I/O devices 128, 130, 132 etc. There is also a second communication network 134 to which the first PLC device PLC#1, 114 is connected. The control bus 134 is intended to enable communication between I/O devices connected to the second communication network 134 and the first PLC. Hence, the first PLC has access to the I/O devices and acts as a gateway between the first communication network 106 and the second communication network 134.

It should be noted here that the example platforms presented in FIGS. 1a-1c are only simplified examples and in practical implementations the platforms may comprise many devices acting as nodes in the communication network, and there may also be a large number of I/O devices, actuators, sensors and other elements to enable the operation of the mining apparatus. Furthermore, one mining apparatus may comprise several different platforms which may or may not communicate with each other. For example, there may be one platform for controlling the operation of the engine, transmission, brakes and lights of the mining apparatus and another platform for controlling the operation of the tools, boom(s) etc. of the mining apparatus. There may be a gateway between the first platform and the second platform.

As a part of the development of the mining apparatuses, also the control platform is continuously developed. Thus, new software releases improving various parts of the control platform are created. Also new versions of the operating systems underlying the control platform are released. New operational functions are developed for the nodes, thus requiring an updated software module for controlling the functions. When carrying out maintenance of the mining apparatus, new hardware components, such as actuators or sensors, may be installed. This may require an update of firmware of the component.

The control software modules for the various nodes of the control system may comprise application software and/or firmware. Herein below, the term “firmware” refers to a software module to be installed and used in control of a particular type of hardware component provided by a third party.

Each of the above situations may raise a need for upgrading the software and/or firmware of the control system of the mining apparatus.

It is desirable that the upgrade process is carried out such that the interruption in the operation of the mining apparatus will be as short as possible. It is further desirable that the upgrade process can be carried out by personnel without any specific skills in computers. It is further desirable that the upgrade process can be carried out without any network connection. It is yet further desirable that the upgrade process is comprehensive in the sense that it enables a centralised documentation and lifecycle management of the control system of each individual mining apparatus.

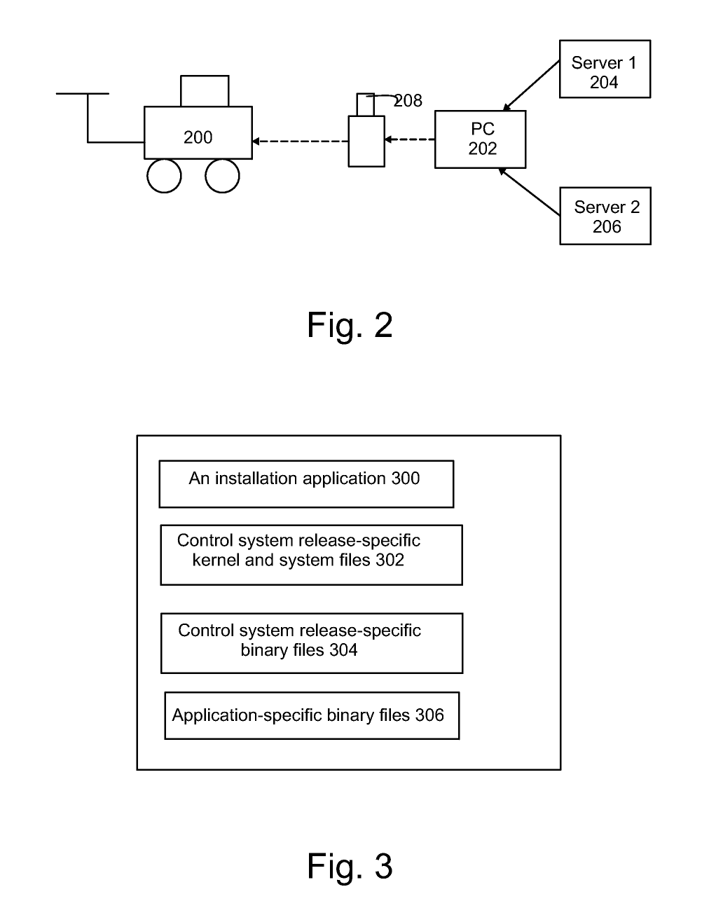

An aspect of the invention, which relates to an improved upgrade process for the control system of a mining apparatus will now be described in accordance with the embodiments submitted below. FIG. 2 illustrates the general arrangement underlying the embodiments.

FIG. 2 discloses a mining apparatus 200 requiring an upgrade of software and/or firmware of the control system. A mining apparatus 200 may be located in its operational place used, for example, for rock excavation in a surface or underground operating area. A computer 202 is arranged to gather and compile the files and any related data needed for the upgrade. The computer 202 may be connected to a first server 204, which may comprise files and data of the control system platform used the particular mining apparatus type. Thus, the first server 204 may create a so-called product software build, which is delivered to the computer 202, for example, via a network connection or by a memory medium. The computer 202 may further be connected to a second server 206, which may comprise files and data relating to the individual mining apparatus in question, for example sales data relating to ordered individual configurations of the mining apparatus in question or data about the spare parts used in the mining apparatus. If necessary, the computer 202 is arranged to include this data in the product software build.

It is worth to notify that for carrying out the embodiments the computer 202 does not need to be connected to a communication network, and thus to any server; it is only required that the computer 202 has obtained the necessary files and data for the upgrade in its memory.

According to an embodiment, for the upgrade of the control system an installation file structure is created, said file structure comprising an installation application and the files and data necessary for the update of the control system. The installation file structure may comprise one or more files logically connected to each other.

According to an embodiment, the upgrade of the control system is compiled into a boot image, which is a disk image file containing the complete contents and structure of the part of the control system to be upgraded. A boot image includes boot and data recovery information, which allows the associated control system to boot, when initiating the boot process from the boot image.

According to another embodiment, the installation application stored in the installation file structure is initiated in response to a boot command from the control system, whereupon the installation application starts to execute the upgrade process by updating the files and data necessary for the update of the control system. Thus, any boot image file is not necessarily needed for the upgrade of the control system.

The computer 202 comprises a software application for creating the installation file structure. The computer 202 is arranged, by means of the application, to prepare and store the installation file structure into a portable memory medium 208, such as a USB flash drive, an optical memory medium (e.g. CD or DVD disc), a memory medium of a laptop computer, a PDA device or a mobile phone, or any memory medium provided with data transfer means, such as a NFC (Near-Field Communication) tag. Thus, since the installation file structure is stored in the portable memory medium 208, it is not necessary for the computer 202 to locate in the vicinity of the mining apparatus 200 requiring an upgrade of software and/or firmware of the control system. The computer 202 may be located, for example, in a different country, and only the portable memory medium 208 is delivered to the location of the mining apparatus 200.

According to an embodiment, a USB flash drive is used as the portable medium, because in the dusty and vibrating working environment of the mining apparatuses, it is not desirable to use, for example, optical memory devices. The absence of moving parts in USB flash devices enables a more secure implementation, and furthermore, the USB flash devices require only a small place in the control panel compared e.g. to optical drives.

According to an embodiment, regardless of number of nodes requiring update, the upgrade process is normally carried out as a full upgrade, wherein the control software modules (and firmware where applicable) of each node of the control system are upgraded. Thus, the computer 202 creating the installation file structure has always a full documentation of the file versions used in each upgrade of an individual mining apparatus. This facilitates the lifecycle management of the control system of each individual mining apparatus

The portable memory medium 208 is delivered to the mining apparatus 200, whereupon a maintenance person or an operator of the mining apparatus may connect the portable memory medium 208 to a node of the mining apparatus, for example to the control panel of the mining apparatus, and initiate the update process. For initiating the update process, it is thus only required that a portable memory medium comprising an appropriately created installation file structure stored thereon is functionally connected to one or more predefined nodes of the mining apparatus. The predefined nodes may be, e.g. a supervisor devices (SUP-PC), such as computers, connected to the communication network of the control system, which predefined nodes are capable of carrying out the update process of the control system.

The upgrade process may thus be carried out as on-site maintenance, whereby there is no need to transfer the mining apparatus to any service point and the interruptions in the operation of the mining apparatus are minimized. Moreover, no network connections are required for the upgrade process.

The rights for performing the upgrade are preferably connected to the access rights of the person; only a person with sufficient level of access rights may initiate the upgrade process.

According to an embodiment, the boot sequence of the installation file structure is initiated in response to a command, such a keystroke, from the display unit of the control panel of the mining apparatus. Once started, the progress of the upgrade process may be monitored from the display. Thus, carrying out the upgrade process does not require any specific skills in computers.

FIG. 3 discloses an example of preparing an update image into a USB flash drive (a.k.a. USB key) using system-specific imaging software. The imaging software is an application to be executed in a computer, and it is arranged to provide the USB flash drive with a boot image including the necessary files for the update of the control system of a mining apparatus. The imaging application may comprise a user interface for selecting the appropriate control system files to be used in the SW update and for carrying out the creation and installation of the boot image into the USB flash drive.

According to an embodiment, as shown in FIG. 3, the boot image is provided with an installation application 300, higher control level-related files, such as control system release-specific kernel and system files 302, control system release-specific binary files 304 and lower control level-related files, such as application-specific binary files 306. According to an embodiment, these files may further include firmware update files, for example, for the operating system (such as Linux) underlying the control system (i.e. higher control level), for the programmable nodes (PLCs) and/or for actuators and sensors provided by third parties (i.e. lower control level).

It is possible that while the control system may be run on a first operating system, such as Linux, the machine type-specific applications may be built with tools based on another operating system, such as a version of Windows. According to an embodiment, in order to facilitate the installation of the files from the boot image in such a case, the boot image created in the USB flash drive may comprise at least two partitions with different file systems. The first file system may be, for example, suitable for the operating system underlying the control system, such Ext2 or Ext3 (Second/Third Extended File System) suitable for Linux. The second file system may be, for example, suitable for the operating system used in the application software, such as FAT32 (File Allocation Table) or NTFS (New Technology File System) suitable for Windows-based files.

According to an embodiment, in addition to these control system-specific files and machine type-specific files, the boot image may also comprise machine-specific files to be installed only in particular one or more machines.

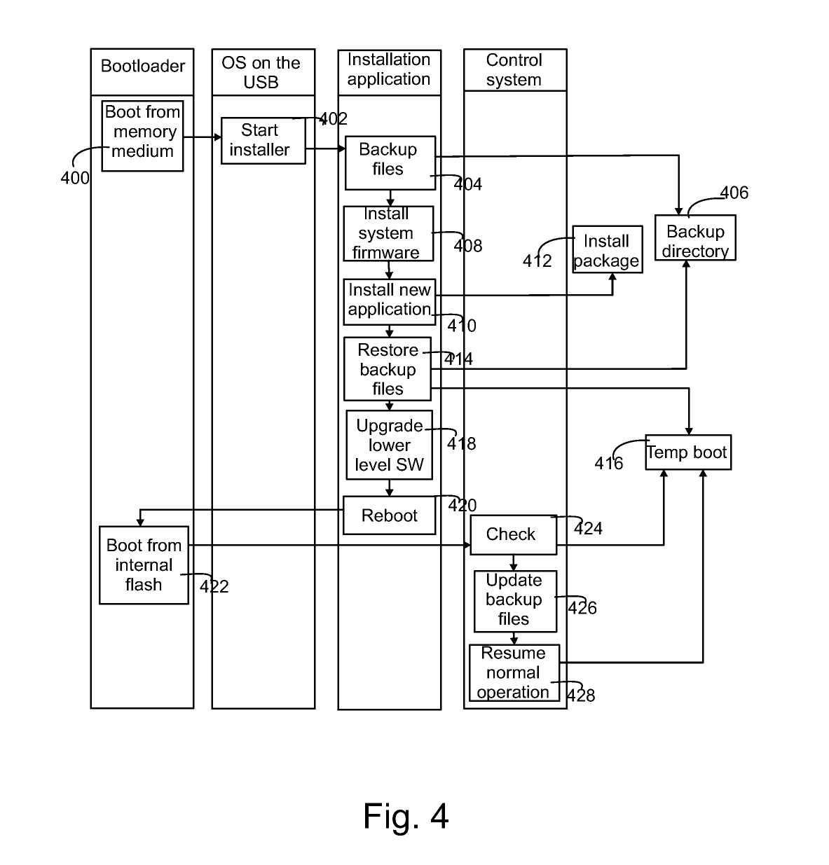

Another aspect of the invention, which relates to an upgrade process for the above-described control system from an image file will now be described in accordance with the embodiments submitted below. FIG. 4 discloses an upgrade process of the control system according to an embodiment. The portable memory medium comprising the boot image is arranged in a functional connection with the control system of the mining apparatus. For example, if a USB flash drive is used, then the USB flash drive comprising the boot image is connected to a USB plug of the mining apparatus. Preferably, the USB plug is directly or functionally connected to the control panel of the mining apparatus. The boot image on the USB flash drive comprises a bootloader application, which in response to a particular user command initiates 400 the boot process from the USB flash drive and starts 402 the execution of the installation application.

According to an embodiment, said user command may be given via the control panel of the mining apparatus, for example by pressing a key or a combination of keys of the control panel. The installation application may then provide the user with information about the progress of the installation process via a display of the control panel.

Altogether, using the installation application, which is separate from the control system, for running the upgrade process gives the advantage that the whole upgrade process can be made independent of the control system and its versions. Furthermore, since the configuration of the firmware of many hardware components has to be defined separately, for example in terms of communication protocol conversions or baudrate to be used, it is easier to implement these configurations directly to the installation application. Some of these configurations may even imply such constrains that could possibly be not handled, if the installation were carried out within the control system.

Since the upgrade process of the control system may include firmware upgrades as well, whereupon the existing file system of the control system is completely erased, the installation application takes 404 a backup copy of various files before the installation. These files may include, for example, alarm and event logs, counter values, parameter values and application defined files. The backup copy is stored in a backup directory 406.

Next the possible firmware upgrade files are installed 408 in the control system. Since the configuration of the firmware to be upgraded typically varies in each upgrade process, depending on the availability of new firmware upgrades for the operating system of the control system, the PLCs and/or the actuators and sensors of the third parties, it is beneficial to have the boot sequence configurable such that new scripts for any firmware upgrade can be easily added to the boot sequence. The steps of the boot sequence may be stored, for example, in a separate, editable configuration file, which the installation application retrieves from a memory.

This provides the advantage that spare parts for the mining apparatus, such as new actuators and sensors, can be ordered directly from a supplier to the location of the mining apparatus. The spare parts can be installed as on-site maintenance, and then the upgrade process ensures that a correct firmware is installed for the new spare part. This enables to minimize any interruptions in the operation of the mining apparatus, because it is not necessary to convey the mining apparatus to a service point for the maintenance.

After the completion of the firmware upgrade process, one or more new versions of applications relating to different operations of the control system are installed 410, whereupon an install package 412 for each new application version is installed within the control system of the mining apparatus. This completes the installation of the higher-level applications of the control system, and thus the files from the backup directory 406 can be restored 414. On the basis of the higher-level upgrade so far, a temporary boot file 416 can be created and stored in the control system of the mining apparatus.

According to an embodiment, upgrade process of the control system is preferably carried out as a full upgrade, i.e. the boot sequence is arranged to upgrade the control software modules (and firmware where applicable) of each node, i.e. processors, PLCs, actuators, sensors, etc. This facilitates to maintain a comprehensive lifecycle documentation of the control system, when no individual software modules are separately upgraded.

However, when creating the boot sequence, the upgrade of each of software modules for these lower-level (i.e. machine control-level) nodes has to be typically treated separately. The upgrade process of a software module of node may vary depending on whether the node is connected to a backbone of the field bus or to a sub-bus. A node can be a master node or a slave node, both types requiring different upgrade approach. If the node is a hardware component of a third party, its specific requirements, e.g. for a communication protocol to be used, have to be taken care of when updating its firmware. Some nodes may require to be switched in a pre-operational state in order to be upgradable, while some other nodes may require to be switched in some other state. It is further possible that some node may not support the communication protocol used in the field bus.

All these constraints have to be considered when creating the boot sequence, which includes the software modules of all the lower-level nodes. The boot sequence of each of the software module is tailored according to requirements of the node. Thus, after the completion of the higher-level upgrade the boot sequence continued by upgrading a plurality of the software modules of the lower-level nodes, either in series or in parallel. In FIG. 4, this is depicted as one step 418, while in practice this may involve upgrading of software modules of hundreds of nodes.

Once all the lower-level nodes included in the boot sequence have been upgraded, the installation application sends the bootloader application a command 420 to reboot the control system of the mining apparatus. In response to the command, the bootloader application initiates 422 the boot process from an internal flash memory of the control system. As a first step of the boot process, it is checked 424 that the temporary boot file 416 is available and the boot process according to the boot sequence of the temporary boot file 416 is initiated and completed. The parameter values and the content of the log files of the nodes may have changed during the upgrade process, in case of which the values should be updated 426. Thereafter, it is possible to resume 428 to normal operation and delete the temporary boot file 416.

The above example discloses a process, wherein the existing software/firmware of at least one node of the control system is upgraded to a new version. It is, however, possible that a software/firmware installation has to be carried out to one or more or even to all nodes without a prior version of the software/firmware existing at the node(s), e.g. as result of a maintenance process of the apparatus. According to an embodiment, the upgrade processes described above are equally applicable to a fresh installation process. It is only required that each node to which software/firmware is to be installed is capable of informing its node identity to the installation application. In addition, the node may be capable of informing a communication protocol to be used, its address in the communication bus and/or a baudrate to be used in the communication. Provided that control software module comprising software/firmware for said node is available, the installation application is capable of installing the software/firmware for said node on the basis of the identity of the node.

A skilled man appreciates that any of the embodiments described above may be implemented as a combination with one or more of the other embodiments, unless there is explicitly or implicitly stated that certain embodiments are only alternatives to each other.

The various embodiments of the invention can be implemented with the help of computer program code that resides in a memory and causes the relevant apparatuses to carry out the invention. For example, a work machine may comprise circuitry and electronics for handling, receiving and transmitting data, computer program code in a memory, and a processor that, when running the computer program code, causes the machine to carry out the features of an embodiment.

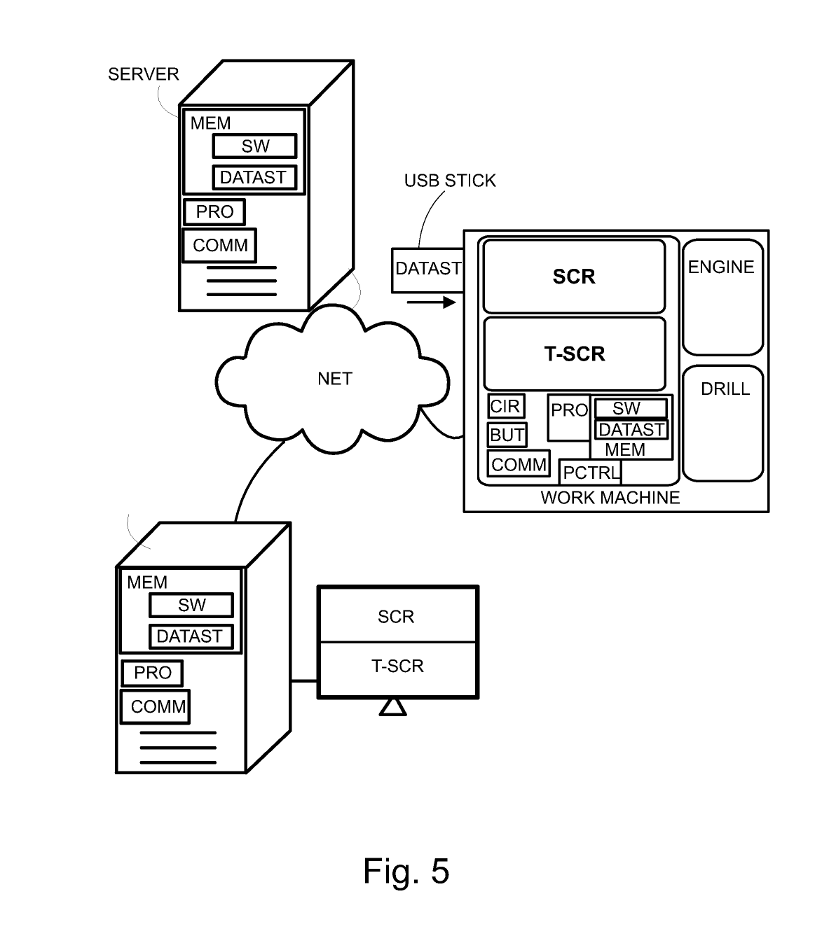

FIG. 5 shows a block diagram of a system for carrying out an update process of the control system of a work machine. The system comprises one or more processors PRO, and memory MEM. The processors and memory may be in one part of the system or distributed across different parts and different apparatuses. For example, a work machine control interface may have its own processor and/or memory, a computer connected to the work machine its own processor and memory, and other parts of the system their own. The memory MEM may comprise software SW executable on the processor PRO so that the system may display items to the operator via a screen SCR and accept input through buttons BUT, physical controls PCTRL like levers and joysticks, and/or through a touch screen T-SCR. A part or all of the steps of an embodiment may be carried out in software, and a part or all of the steps may be carried out by control circuitry CIR. The software may reside on a computer-readable non-transitory medium such as a USB stick or a data disc, and the computer program code is stored on said medium. Such a computer program product may be used to deliver the functionalities of the invention to a system by installation or by using the computer-readable medium directly for executing the program therefrom. The system may comprise communication modules COMM for sending and receiving data between the different parts and apparatuses of the system.

The system is provided with a data structure DATAST storing the installation file structure. This data structure may be stored on a computer-readable non-transitory medium such as a USB stick or a data disc, and the data structure may be delivered to the system on a USB memory stick that is plugged in to the system for string the update process. Additionally, the data structure may be stored to the memory of a computer and/or a server (c.f. FIG. 2)

In such a system, when the computer-readable non-transitory medium comprising the data structure storing the installation file structure is connected to the system, it causes the system to read an installation file structure from a the computer-readable non-transitory medium connected to the control system, and in response to detecting a user command, start an update process of the control system from an installation file structure stored on said portable memory medium.

As a further aspect of the invention, there is provided a computer program product comprising computer program code for carrying out an update process of the control system of a work machine, the computer program code which, when executed by a processor, causes the work machine to perform: reading an installation file structure from a portable memory medium connected to the control system; and in response to detecting a user command, starting an update process of the control system from an installation file structure stored on said portable memory medium.

It is obvious that the present invention is not limited solely to the above-presented embodiments, but it can be modified within the scope of the appended claims.

1. A method for updating software of a control system of a working machine, the method comprising the steps of:
creating an installation file structure including an installation application and files and data for the update of the control system;
storing said installation file structure on a portable memory medium;
connecting said portable memory medium to the control system of the working machine; and
starting an update process from said installation file structure in response to a command from a control node of the working machine, wherein the installation application is arranged to carry out the update process as a full upgrade, wherein control software modules of each node of the control system are upgraded.

2. The method according to claim 1, wherein the portable memory medium is a USB flash drive.

3. The method according to claim 1, further comprising carrying out the update process, by said installation application, which is executed separately from the control system.

4. (canceled)

5. (canceled)

6. (canceled)

7. (canceled)

8. (canceled)

9. (canceled)

10. (canceled)

11. A working machine comprising:
a software-based control system;
means for connecting a portable memory medium to the control system; and
means for providing a user command for starting an update process of the control system from an installation file structure stored on said portable memory medium, the installation file structure including an installation application and files and data for the update of the control system, the installation application being arranged to carry out the update process as a full upgrade, wherein control software modules of each node of the control system are upgraded.

12. (canceled)

13. The working machine according to claim 11, wherein the portable memory medium is a USB flash drive.

14. (canceled)

15. (canceled)

16. (canceled)

17. (canceled)

18. The working machine according to claim 11, wherein said installation file structure is a boot image file, said boot image file including the installation application, a control system release-specific kernel and system files, and control system release-specific binary files and application-specific binary files.

19. The working machine according to claim 11, wherein a display unit of the control panel includes said means for providing the command starting the update process, and said display unit is arranged to receive information regarding the progress of the upgrade process from the installation application to be shown on the display unit.

20. (canceled)

21. The working machine according to claim 1, wherein the working machine is selected from the group of a drill rig, a loader, a dumper, a crushing and screening apparatus, a conveyor, a road header, a continuous miner and a bulk material handling device.

22. A system for carrying out an update process of a control system of a work machine, the system comprising:
a control interface for receiving control input from an operator;
a processor;
a memory including computer program code; and
an installation file structure including an installation application and files and data for the update of the control system, the memory and the computer program code configured to, with the processor, cause the system to read the installation file structure from a portable memory medium connected to the control system, and in response to detecting a user command, start an update process of the control system from an installation file structure stored on said portable memory medium, wherein the installation application is arranged to carry out the update process as a full upgrade, control software modules of each node of the control system being upgraded.

23. A computer program product comprising computer program code for carrying out an update process of a control system of a work machine, the computer program code which, when executed by a processor, causes the work machine read an installation file structure from a portable memory medium connected to the control system and in response to detecting a user command, to start an update process of the control system from an installation file structure stored on said portable memory medium, wherein the installation file structure includes an installation application and files and data for the update of the control system, wherein the installation application is arranged to carry out the update process as a full upgrade, wherein control software modules of each node of the control system are upgraded.

24. The computer program product of claim 23, wherein the computer program product comprises a computer-readable non-transitory medium such as a USB stick or a data disc, and the computer program code is stored on said medium.

25. A computer-readable non-transitory medium comprising a data structure for controlling a node of a control system of a work machine to update software of the control system, the data structure including an installation application and files and data for the update of the control system, wherein the data structure of the installation application is arranged to carry out the update process as a full upgrade, wherein control software modules of each node of the control system are arranged to be upgraded.

26. The method according to claim 1, the further comprising compiling said installation file structure into a boot image file, wherein said boot image file includes the installation application, control system release-specific kernel and system files, control system release-specific binary files and application-specific binary files.

27. The method according to claim 26, wherein said boot image file is partitioned into at least two partitions, a first partition used for control system related files and a second partition used for application-specific binary files.

28. The method according to claim 1, further comprising the step of providing the command starting the update process from a display unit of a control panel and submitting information regarding the progress of the upgrade process to the display unit.

29. The method according to claim 28, further comprising the step of checking access rights of a user of the mining apparatus, and allowing the command starting the update process to be provided only in response to the access rights of the user being on a predetermined level.
